(19) United States
(12) Patent Application Publication
(10) Pub. No.: US 2003/0179889 A1
(43) Pub. Date: Sep. 25, 2003

(54) [Wireless Adapter for Wired Speakers]

(75) Inventor: Daniel Kozak Pivinski, Voorhees, NJ (US)

Correspondence Address: DANIEL KOZAK PIVINSKI, 6222 MAIN STREET, VOORHEES, NJ, 08043, US

(73) Assignee: Daniel Kozak Pivinski, Voorhees, NJ (US)

(21) Appl. No.: 10/250,136

(22) Filed: Jun. 5, 2003

(51) Int. Cl. H04B 3/00; H04B 5/00

(52) U.S. Cl. 381/79; 381/77

(57) ABSTRACT

This invention discloses a wireless adapter for use in wireless audio systems. The invention incorporates a radio frequency receiver, an amplifier, a modulator, a standard speaker-wire output port, and a power system. The radio frequency receiver provides for reception of transmitted audio information in remote locations. The amplifier increases the magnitude of the signal from a radio frequency transmitter. The modulator alters the received information digital or otherwise into a format usable to standard wired audio speakers. The output port provides for a means of connecting standard speaker wire from the invention to standard wired speakers. And the power system connects the invention to an external power source vis-Ã-vis a standard power wire or power plug.

### BACKGROUND OF INVENTION

The present invention relates generally to wireless local audio transmission and specifically to an adapter for use in wireless audio systems.

A number of systems have been developed to avoid wiring stereo speakers directly to the source of signals used to drive the speakers, e.g., phonographs, tape decks, CD players, or AM/FM tuners. By way of example, U.S. Pat. No. 4,829,570, issued to Larry Schotz on May 9, 1991, discloses a system of this type. This system, while not requiring direct wiring between the source of signals and the speaker, transmits the signals over the A.C. electrical conductors of the building in which the system is located. The signals transmitted in this manner are subject to certain undesirable effects, such as filtering for computer systems. This type of filtering may eliminate or degrade the signals intended for transmission to the speakers. An alternative to using any form of wiring between a speaker and the source of signals for driving the speaker is to transmit the signals over the air via electromagnetic waves such as radio waves. This type of system requires the use of a transmitter for transmitting the signals, a receiver for receiving the signals at the speaker, and a power amplifier for amplifying the signals at the speakers to properly drive the speakers. The drawback with this type of system is that the FCC strictly regulates the frequencies at which information may be transmitted over the air without the requirement of an appropriate license. Additionally, the number of frequencies at which transmission may occur is limited. Currently, the frequency bands available for transmitting information using low power transmission without a license are at high frequency ranges. For example, the FCC currently allows the use of low power transmission (i.e., below 1 milliwatt for conventional modulation or below 1 watt for spread spectrum modulation, 47 CFR .sctn.15.249) in the range of 902 to 928 MHz, 2.4 to 2.483 GHz and 5.725 to 5.875 GHz. Such wireless speaker systems are disclosed in U.S. Pat. No. 5,299,264 (Schotz et al.) issued on Mar. 29, 1994 and U.S. Pat. No. 5,581,617 (Schotz et al.) issued on Dec. 6, 1996. Another related type of wireless speaker system is disclosed in U.S. Pat. No. 5,491,839 (Schotz) issued on Feb. 13, 1996 and which discloses a system for simultaneously transmitting a plurality of audio source signals to wireless speakers. Wireless speaker systems are desirable, since wiring is not required between the speakers and source of signals for driving the speakers; however, an arrangement of this type is not practical if the quality of the information signal driving the speaker is poor. Stereo speaker applications require high signal-to-noise ratios, good frequency response, low distortion, and stereo capability (simultaneous transmission of two channels of information) to be practical. A wireless speaker system is not a replacement for a system using wires unless the quality of information signals provided to drive the speakers results in a sound at the speakers comparable with the sound at similar speakers in a system using wires. Moreover, a wired speaker system does not teach nor even suggest the implementation of a wired speaker system for the following reasons. A wired speaker system can have a wire or bus dedicated to a particular signal(s) that is directly transmitted from the audio source to the speaker(s). The audio source and speakers are thus always electrically coupled together. Because the signal(s) are confined to the wire/bus, signal errors due to noise can be overcome by increasing the power carried through the wire/bus; in some cases, the speaker can even communicate back to the audio source over this wire/bus. In contradistinction, a wireless speaker system is susceptible to RF dropouts or loss of data due to RF interference, low signal strength, multipath, etc., (e.g., someone standing in front of the transmitter antenna or even touching it); the result is that the receiver can do nothing but await another transmission from the transmitter. Furthermore, because there is no wire/bus between the transmitter and the receiver, there must also be a method of almost instantaneous resynchronization in place between the transmitter and the receiver in order to prevent gaps or “dead time” in the audio signal. In addition, the wireless speaker system is not permitted to increase power to overcome signal errors due to noise as is permitted in wired speaker systems as discussed above; to meet FCC guidelines the power permitted for transmitting such high fidelity stereo audio signals over the air must not exceed a certain power level (e.g., 1 mW for the 900 MHz range, and the 2.4 GHz range where spread spectrum modulation is not used).

In addition, many compact disc players and digital audio tape players provide digital audio data output outlets, as well as analog audio data output outlets. In many instances, the speakers are hard-wired to the analog audio output outlets, rather than to the digital audio output outlets. The problem with this is that the compact disc players and digital audio tape players process the audio signal digitally and then must convert the audio signal back to an analog signal for transmission over the speaker wire for ultimate use by the speaker. Such digital to analog conversion introduces additional signal distortion at the player before transmission on the line. It would be desirable to directly use the digital version of the audio signal (available at the digital audio data output outlets), thereby keeping distortion to a minimum, and then making the digital to analog conversion as close to the speaker as possible, after transmission is completed. The transmission/reception of audio signals, e.g., music, (approximately 20 Hz to 20 kHz) must be distinguished from the transmission/reception of voice signals (approximately 300 Hz to 3 kHz). The former requires wideband transmission while the latter requires only narrowband transmission. Furthermore, where the transmission/reception of audio signals is accomplished using digital techniques, the transmission bandwidth must be further widened based on audio source sampling frequency, the standard use of two channels for audio, the number of bits per channel and any encoding process. These factors can easily require a significant transmission bandwidth. As stated earlier, a wireless speaker system is no replacement for a wired speaker system if the quality of the information signals required to drive the speakers is poor. Thus a wired digital speaker system, such as the one disclosed in U.S. Pat. No. 5,406,634 (Anderson et al.), does not encounter any of the problems of a wireless speaker system (as discussed above) nor does it encounter the following problems of a digital wireless speaker system. In particular, the transmitter in a digital wireless speaker system must create a continuous digital data stream from the audio inputs (e.g., a left and right stereo channel) and then transmit that serial digital data stream over the air to a remote receiver. The receiver must be able to take the single digital data stream and recreate the multiple signals while minimizing bit errors. Furthermore, the recreation of high fidelity sound from a single digital data stream requires a high data rate transfer (e.g., 1.4 Mbps digital audio bit rate) from the transmitter to the receiver and the receiver must be precisely synchronized to provide such high fidelity recreation. Synchronization between the transmitter and the receiver in a digital wireless speaker system is severely complicated because of (1) the need to perform initial data synchronization, (2) the ability to continuously resynchronize and (3) the need to perform data clock recovery. Implementing a digital wireless speaker system requires a continuous method of data synchronization because the system is continuous, real time system which operates at such a high digital audio bit rate (1.4 Mbps); if RF dropout should occur, the system cannot simply resend the data but rather the system must be able to automatically resynchronize and it must do so at the high digital audio bit rate. If the receiver of the system is unable to automatically synchronize, the resultant stereo audio input is interrupted, thereby degrading the system performance. The synchronization is comprised of two components, the initial synchronization and resynchronization. Once the wireless speaker system obtains initial synchronization from an embedded synchronization code in the received data, the receiver then must monitor the data to insure it stays synchronized. If the system loses synchronization from an RF artifact, it then must have a method to resynchronize quickly. Furthermore, a wireless digital audio system is complicated by the fact that not only must data synchronization be performed, but data timing or bit timing must also be synchronized-with the transmitter. A wired digital speaker system does not have to concern itself with bit timing because the transmitter and receiver clock signals can be obtained from the same source. In contradistinction, even the smallest error in clock rates between the wireless digital audio transmitter and the wireless digital audio receiver will result in bit errors in the receiver and synchronization could be lost. Thus, there is a need for a high speed clock recovery circuit that locks onto the transmitter's clock. Many digital data systems send packets of information from which the receiver synchronizes. However, in a wireless system, it is unknown when at which point data will be lost and upon return of the data there must be synchronization without waiting for a packet or other header information. Failure to synchronize as such causes the audio to appear interrupted, i.e., non-continuous, and it would degrade the system performance. To send such packets in a digital wireless speaker system to be able to resynchronize in a small period of time would require very small packets but would require impractical data rates due to the added overhead. It should also be understood that communication systems, e.g., personal communication systems (PCS) such as that disclosed in U.S. Pat. No. 5,392,300 (Borth et al.) do not teach nor suggest the implementation of a digital wireless speaker system. Although a PCS comprises a transmitter and receiver that may operate in the 900 MHz or even the 2.4 GHz range, operation of a PCS transmitter/receiver is totally different from the operation of a wireless speaker system. In particular, the audio content of a PCS, i.e., voice, is different from the audio content of a wireless speaker system, i.e., high fidelity stereo sound; as stated earlier, the former requires only narrowband transmission whereas the latter requires wideband transmission. Second, the data rate of a PCS that utilizes digitized speech/voice information (e.g., approximately 64 kbps) is nowhere near the approximate 1.4 Mbps digital audio bit rate necessary for high fidelity sound. Finally, all previous art and marketed products digital or otherwise—fail to incorporate traditional stand-alone speakers into their system and to provide for a power supply that does not require periodic replacement. Instead, existing wireless speaker systems incorporate wireless receiver technology with speaker components which fails to allow for use of the said traditional speakers. The invention effectively solves this problem thereby allowing users to either utilize their own or to purchase new wired speakers for use in a wireless speaker system. The benefits of this allowance include minimizing users″ costs to transform their wired system into a wireless system as well as affording them the ability to purchase speakers and other components from a vastly wider pool of marketed equipment, which gives them the option of maximizing the resulting quality and aesthetic appearance of their wireless audio systems. As stated, existing prior art and available products also fail to incorporate a power system that does not require periodic replacement of power supply. This shortfall requires additional cost and effort on the part of the user in order to maintain the viability of their wireless system. The invention addresses this problem by incorporating a steady, inexpensive, reliable power system that ties into existing electrical systems by means of a power plug or wire. While doing so necessitates the need for a wire (power wire) in their wireless audio system, this solution″s benefits of cost reduction, reliability and convenience far outweigh the aesthetic problem of hiding an exposed power wire, whether or not the user chooses to hide the power wire inside a wall.

Accordingly, the need exists for a wireless speaker adapter for use with available and future wireless transmitting technology capable of incorporating the use of standard wired speakers into a wireless audio system and providing a constant power supply to its internal components.

### DETAILED DESCRIPTION

Accordingly, it is the general object of this invention to provide an apparatus which overcomes the disadvantages of the prior art.

It is a further object of this invention to provide for the use of traditional wired speakers with a wireless speaker system.

It is a further object of this invention to provide for a steady, inexpensive, reliable power system within a wireless speaker system that ties directly into existing electrical systems thereby eliminating the necessity by the user to periodically replace a wireless speaker″s power source.

It is a further object of this invention to reduce the expense of a wireless speaker system by eliminating the need to provide another component a speaker within a marketed wireless speaker system.

It is a further object of this invention to provide users with more choices as to which speakers they employ within their wireless speaker system.

It is a further object of this invention to maximize the quality of output of a wireless speaker system by allowing users to choose the speakers they prefer.

It is a further object of this invention to maximize the subjective aesthetic appearance of a wireless speaker system by allowing users to choose the speakers they prefer.

It is a further object of this invention to increase the convenience of maintaining a wireless speaker system by eliminating the necessity by the user to periodically replace a wireless speaker″s power source.

These and other objects of the invention are achieved by incorporating a radio frequency receiver, an amplifier, a modulator, a standard speaker-wire output port, and a power system. The radio frequency receiver provides for reception of transmitted audio information in remote locations. The amplifier increases the magnitude of the signal from a radio frequency transmitter. The modulator alters the received information digital or otherwise into a format usable to standard wired audio speakers. The output port provides for a means of connecting standard speaker wire from the invention to standard wired speakers. And the power system connects the invention to an external power source vis-Ã-vis a standard power wire or power plug.

The invention allows users to utilize standard wired speakers in a wireless speaker system and provides for a consistent power supply to the output components of that system. Among other benefits, the invention augments the usability, output quality, and cost-effectiveness of radio frequency transmitter-based wireless speaker systems.

1. A wireless audio speaker adapter for use with a wireless audio transmitter and at least one traditional wired speaker, said adapter arranged for connecting a traditional wired speaker to a wireless audio system and providing a constant power supply to its components, said adapter comprising:
A radio frequency receiver for reception of transmitted audio information in remote locations;
An amplifier to increase the magnitude of the signal from a radio frequency transmitter;
An output port to provide for a means of connecting standard speaker wire from the invention to standard wired speakers;
A power system to connect the invention to an external power source vis-Ã-vis a standard power wire or power plug and supply power to the invention's components.
